(19) United States
(12) Patent Application Publication
(10) Pub. No.: US 2003/0216837 A1
(43) Pub. Date: Nov. 20, 2003

(54) Artificial environment control system

(76) Inventors: Daniel Reich, Tucson, AZ (US); Vladi Reich, Tucson, AZ (US); Boris Kaplinsky, Sierra Madre, CA (US); Oleg Pavlenko, Saint-Petersburg (RU)

Correspondence Address: DURANDO BIRDWELL & JANKE, P.L.C., 2929 E. BROADWAY BLVD., TUCSON, AZ, 85716, US

(21) Appl. No.: 10/383,178

(22) Filed: Mar. 6, 2003

Related U.S. Application Data
(60) Provisional application No. 60/362,334, filed on Mar. 8, 2002.

(51) Int. Cl. G01M 1/38; G05B 13/00; G05B 15/00; G05B 21/00; G05D 23/00

(52) U.S. Cl. 700/276; 700/278; 236/1 C

(57) ABSTRACT

Multiple AECS sensors are attached to workstations or personal computers. A Local Area Network (“LAN”) connects the computers, and, by extension, the AECS sensors to system controllers. The system controllers direct the behavior of HVAC equipment such as variable air volume (“VAV”) boxes, fans, heaters, and air conditioners. An Energy Management Server (“EMS”) is utilized to gather information regarding current utility rates and weather forecasts. Individual users may request environmental set-points using application software residing on the computer. A composite set-point may be generated using a weighted average algorithmic calculation. Requests from disparate users may be given varying weight in determining the composite set-point.

This application claims the filing date benefit of U.S. Provisional Patent Application Ser. No. 60/362,334, filed Mar. 8, 2002, which is incorporated by reference in its entirety for any purpose.

### BACKGROUND OF THE INVENTION

1. Field of the Invention

This invention is related in general to the field of artificial environmental control systems for commercial, institutional, residential, and industrial buildings. In particular, the invention comprises utilizing distributed artificial environment control system sensors attached to work stations or personal computers to gather parametric environmental information and transmit this information to environmental control systems. Users may request modifications to local environmental set-points using a software application.

2. Description of the Prior Art

It is very common to use electo-mechanical devices to control any of a myriad of different types of artificial environmental equipment, such as air conditioners, variable air volume boxes (“VAV”), fans, or lighting. These electro-mechanical devices, referred to as controllers, often can be quite sophisticated and capable of performing advanced algorithmic calculations. For example, heating, ventilation, and air conditioning (“HVAC”) controllers often possess computer processors used to analyze and respond to changes in temperature, pressure, and humidity. Some controllers can even develop efficient heating and cooling plans in response to anticipated weather patterns.

Sensors are used to sample environmental conditions and transmit the data to the controllers in the form of parametric values. For example, a controller used to activate a variable-speed exhaust fan may utilize a temperature sensor to report the ambient air temperature in a room. A controller directs the behavior of attached equipment according to behavior algorithms, using parametric set-points as triggers. In the example of the variable-speed exhaust fan, the controller may be set to activate a fan when the ambient air temperature exceeds 90 degrees and linearly increase the fan speed as the temperature increases until the fan has reached its maximum rate of revolution. Additional parameters may be provided as triggers for messages or alarms. For example, if the ambient air temperature exceeds a predetermined parameter or the exhaust fan is spinning at an unacceptable rate, a message or alarm may be generated. A computer is sometimes connected to a controller to program its parameters, direct its behavior, and retrieve and display its status information, messages, and alarms.

Controllers can work alone or in clusters. If more than one controller is utilized, a master controller may be utilized to coordinate the effort of the other, slave controllers. In some applications, slave controllers communicate with the master controller via a Local Area Network (LAN) such as an RS485 based LAN.

Artificial environment equipment and its associated controllers may be distributed throughout a single company setting in a large industrial or commercial building. Alternatively, several businesses may occupy discrete areas of a common floor of an office building. In the former, multiple sensors may be used to gather environmental information from the work areas of multiple employees. In the later, multiple sensors are necessary to accommodate the disparate environmental needs of each business. Sensors may be connected to controllers using either wired networks or wireless communications networks such as those embodied by IEEE standard 803.3 or 802.11.

A typical modern building may have hydraulic or air-based heat exchange systems, rooftop air conditioning units, variable air volume boxes, and multi-zone air conditioners. Sensors for measuring temperature, humidity, and carbon dioxide concentration may be permanently installed in the building's walls or ductwork. Additionally, sensors may have a means for accepting environmental set-points. The most basic example is a standard mercury switch thermostat used to both sense the ambient air temperature and transmit a control signal to an associated HVAC unit. The set-point may be set by simply changing the orientation of the cavity containing the mercury.

It is very common for commercial HVAC units to serve large areas divided into multiple rooms or cubicles. It is customary to install a single sensor in each enclosed area. However, in some instances, multiple sensors may be distributed throughout a single enclosed area. Set-point information may be averaged together to produce a cumulative set-point.

The current state of environmental controls is not without a few problems. An artificial environmental control system may become inefficient if permanently installed sensors are not placed proximate to the building's occupational load or heat load distribution. Likewise, properly installed sensor nets may become inefficient if the occupational arrangement is transitory, for example, if departments are consolidated or relocated. Additionally, environmental sensors which are placed along columns or walls may limit the placement of office furniture and equipment.

If a limited number of sensors are used in an enclosed area, contention regarding a desired set-point may arise between multiple occupants. Some occupants may be excluded all-together from the environmental decision-making process. Additionally, in areas where disparate companies occupy a common enclosed area, it may be desirable to allocate a pro-rata portion of utility bills based on the set-point requests of the different companies.

A vast amount of modern industrial and office space is equipped with workstations or personal computers interconnected in a local area network (LAN). In sophisticated control systems, set-points may be requested using these computers. In U.S. Pat. No. 6,338,427, Kline discloses a process for adjusting the temperature of a VAV device through a personal computer.

However, Kline's invention does not address the location or portability of associated sensors. It would be highly desirable to provide for locating sensors at or near the work location of the occupant. For many office workers, the most practical location to position a sensor is near the monitor attached to the computer.

### SUMMARY OF THE INVENTION

This invention is based on utilizing an existing local area network (“LAN”) in a business or industrial facility to gather environmental parameters and set-point requests from multiple users. Artificial environment control system (“AECS”) sensors are located proximate to the workspace of individual users, for example, near a computer monitor. The AECS sensors are connected to workstations or personal computers. While the preferred embodiment of the invention utilizes a universal serial bus (“USB”) connection, an AECS sensor may alternatively be connected to its respective computer using a serial cable, a parallel cable, Firewire® technology, or other means for passing data between the AECS sensor and the computer.

Parametric information such as temperature, humidity, CO2 level, light level, and occupancy, accumulated by the AECS sensors, is transmitted to system controllers via the LAN. Additionally, an Environmental Management Server (“EMS”) is connected to the LAN. A router may be utilized to connect the LAN and, by extension, the system controllers, EMS, and AECS sensors to the Internet. The EMS may utilize this Internet connection to request weather forecast information and current utility rates to assist in generating an efficient artificial environment control plan.

HVAC equipment controls the artificial environment of large buildings in zones. An individual zone may contain several AECS sensors located at the work area of individual users. Each user may utilize a software application to request set-points for his or her work environment, such as temperature and air-flow. If disparate users request different environmental set-points, an algorithm is employed to calculate a composite set-point based on a weighted average of the requests.

One aspect of this invention is to provide a network of AECS sensors which can be configured to match the current occupational load. As occupants relocate within environmental zones, their respective AECS sensors connected to their computers are relocated as well. In this way, the network of AECS sensors dynamically mirrors the occupant configuration of the area.

Another aspect of this invention is to allow multiple occupants to request environmental set-points for the same common area and have a composite set-point algorithmically determined.

Yet another aspect of this invention is to provide a means of utilizing weighted coefficients, wherein disparate users are given unequal weight, to determine the composite set-point.

Another aspect of this invention is to provide a means for connecting the artificial environment control system to the Internet, allowing for the retrieval of current weather forecasts and utility rate information.

Yet still another aspect of this invention is to utilize composite set-points, weather forecasts, and utility rate information to generate efficient artificial environmental control plans.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram providing a general over of an artificial environment control system, according to the invention.

FIG. 2 is an illustration portraying artificial environment control system (“AECS”) sensors attached to workstations, according to the invention.

FIG. 3a is an illustration of an AECS sensor comprising several environmental sensors, a processor, and a universal serial bus (“USB”) connector, according to the preferred embodiment of the invention.

FIG. 3b is an illustration of an alternate embodiment of the AECS sensor of FIG. 3a, including optional carbon dioxide (“CO2”) and infra-red (“IR”) motion detector sensors.

FIG. 4 is a block diagram illustrating the data and power paths of an AECS sensor, according to the invention.

FIG. 5 is a block diagram illustrating a System Controller, with a Master Controller and a plurality of Slave Controllers, according to the preferred embodiment of the invention.

FIG. 6 is a block diagram illustrating the relationship between a User and the software application Environmental Control Console, according to the preferred embodiment of the invention.

FIG. 7 is an illustration of a graphical user interface (“GUI”) of the software application Environmental Control Console, according to the preferred embodiment of the invention.

FIG. 8 is a flow chart illustrating the algorithm utilized to generate a composite set-point, according to the invention.

### DESCRIPTION OF THE PREFERRED EMBODIMENTS

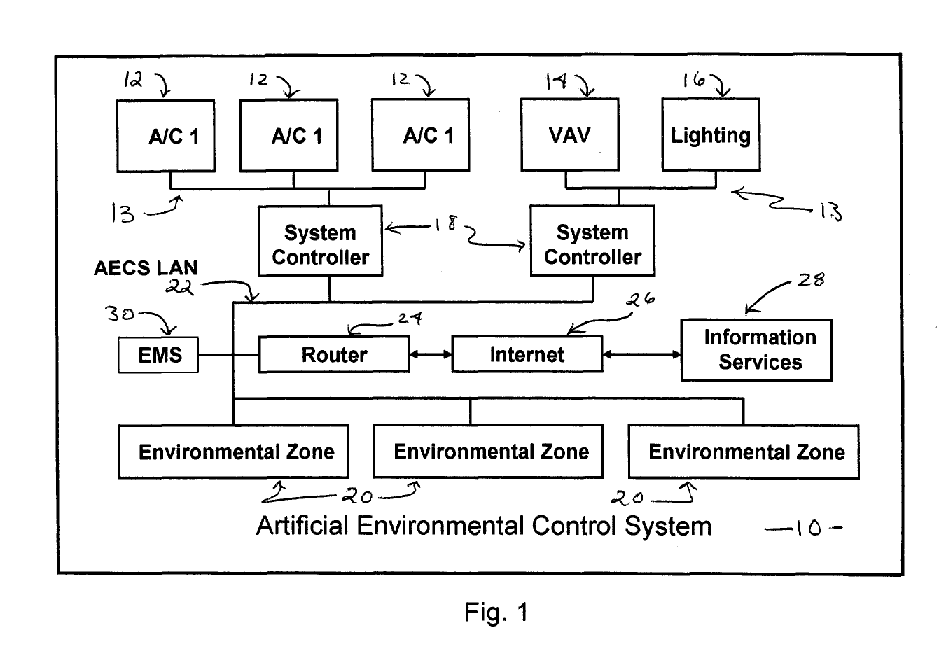

As a general overview of the invention, the block diagram of FIG. 1 illustrates an Artificial Environment Control System (“AECS”) 10. Environmental control devices such as air conditioners 12, Variable Air Volume (“VAV”) boxes 14, and lighting fixtures 16 are to System Controllers 18 to affect the temperature, humidity, and lighting level of Environmental Zones 20. A means for connecting 13 the environmental control devices 12, 14, 16 to the System Controllers 18 such as one or more wires or a set of radio transceivers is provided. AECS sensors located within the Zones 20 communicate with the System Controllers 18 via an AECS Local Area Network (“LAN”) 22. In the preferred embodiment of the invention, the AECS LAN is an Ethernet network, but alternate means for creating local area networks may be utilized. For example, the LAN may consist of a wireless network based on IEEE standard 803.3 or 802.11 or a combination of wired and wireless network technology. A router 24 is used to connect the AECS LAN 22 to the Internet 26. Web Services 28, providing weather forecasts, current weather conditions, and current utility rate information, are accessible through the Internet 26. Additionally, if a user has a load shaving agreement with one or more utility companies, current information regarding the load shaving conditions may be obtained. Likewise, if a user has contractual agreements with multiple providers of like utilities, the Web Services may be queried to determine which utility company is currently providing the best rate. An Environmental Management Server (“EMS”) 30 is utilized to request information from the Web Services 28.

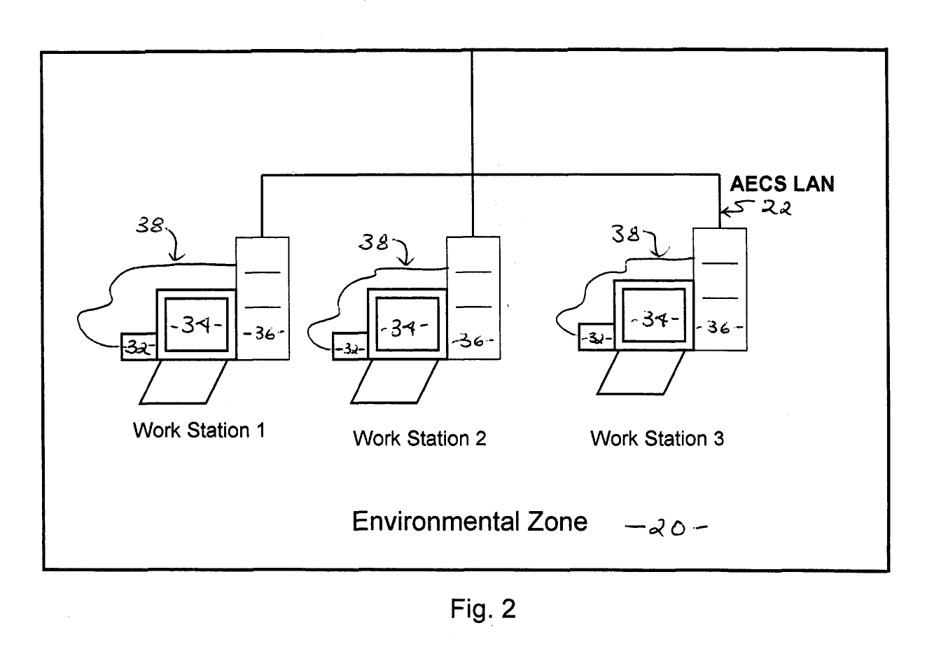

Turning to FIG. 2, AECS sensors 32 are located near computer monitors 34 and attached to computer workstations 36 via a universal serial bus (“USB”) connection 38. A USB connection 38 is convenient as both data and power are available to the AECS sensor 32 via the USB connection. This eliminates the need for an external power source for the AECS sensor 32. An alternate method of connecting the AECS sensors 32 to the workstations 36 is to utilize radio transceivers to transmit and receive data. However, this would require providing an alternate power source for the AECS sensor. The workstations 36 are connected to the AECS LAN 22 of the AECS 10.

In the preferred embodiment of the invention, the AECS sensors 32 are located near or physically attached to the computer monitors 34. This is advantageous in that the area surrounding a computer monitor is most likely to emulate the temperature, humidity, air-flow, and lighting levels experienced by a user. By attaching the AECS sensor 32 to the monitor 34, as users relocate within an Environmental Zone 20, their workstations 36, monitors 34, and associated AECS sensors 32 are usually relocated with them. This allows the configuration of AECS sensors 32 to correlate with the distribution of users in the Zone 20.

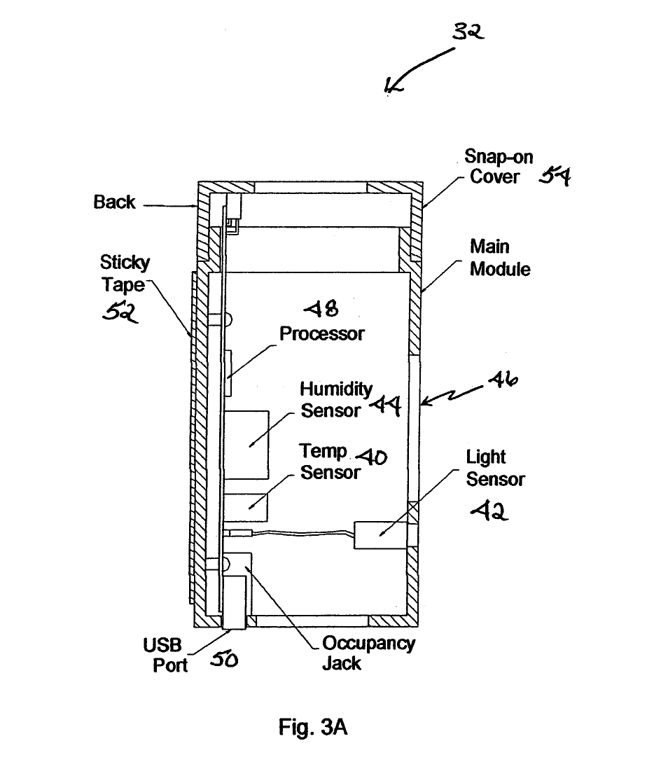

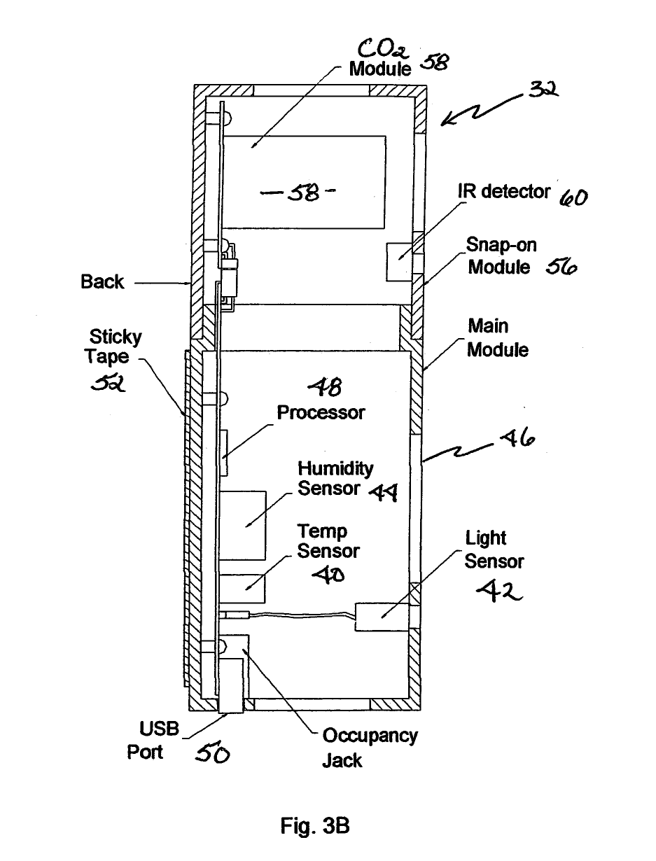

A typical AECS sensor 32, according to the invention, is illustrated in FIG. 3a. Environmental sensors such as a temperature sensor 40, a light sensor 42, and a humidity sensor 44 are placed within an enclosure 46. The enclosure 46 also contains a micro-processor 48 for processing parametric information from the environmental sensors 40, 42, 44. A USB connector 50 provides a data conduit between the processor 48 and the workstation 36. Additionally, the USB port 50 is utilized to provide power for the environmental sensors 40, 42, 44. A cover 54 is used to complete the enclosure 46 and tape 52 may be used to attach the AECS sensor 32 to a computer monitor 34.

FIG. 3b illustrates an optional embodiment of the AECS sensor 32. The cover 54 of FIG. 3a has been removed and replaced with an auxiliary cover 56 which possesses a carbon-dioxide (“CO2”) environmental sensor 58. Yet another optional environmental sensor is an infra-red (“IR”) motion sensor 60 for detecting the presence of a user.

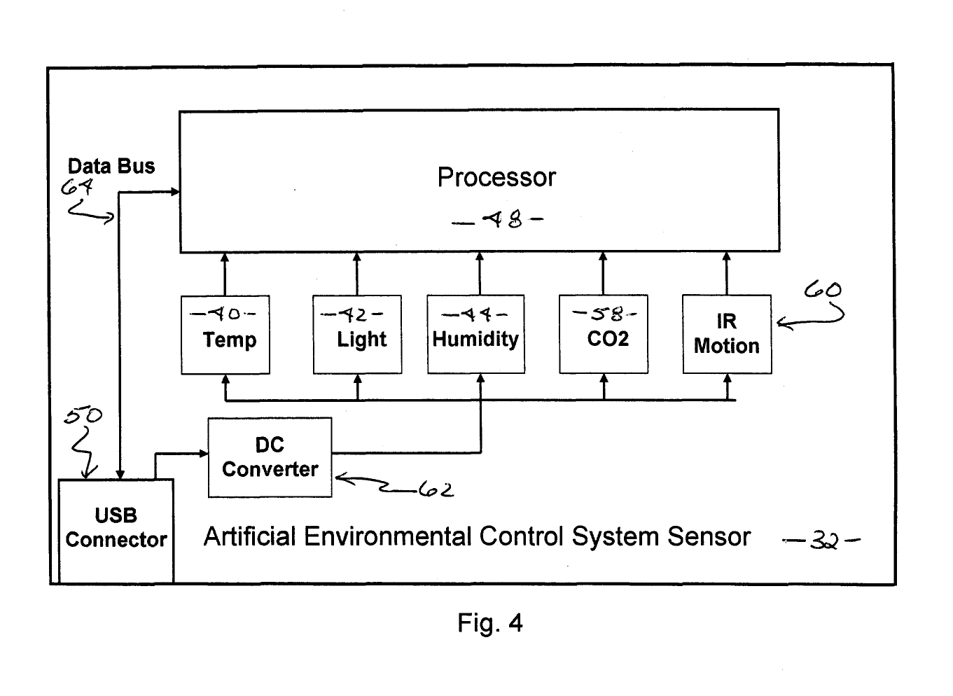

FIG. 4 is a block diagram illustrating the components of the environmental sensor 32 of FIG. 3b, as well as data and power flow within the AECS sensor 32. A DC power converter 62 is used to adjust the voltage of power arriving via the USB connector 50. Once transformed by the DC converter 62, this power is used to energize the various environmental sensors 40, 42, 44, 58, 60. Parametric information is transmitted from the environmental sensors to the micro-processor 48 where it is processed and accumulated. The processed parametric information is eventually transmitted to the USB connector 50, and, by extension, the associated workstation 34 over the data bus 64.

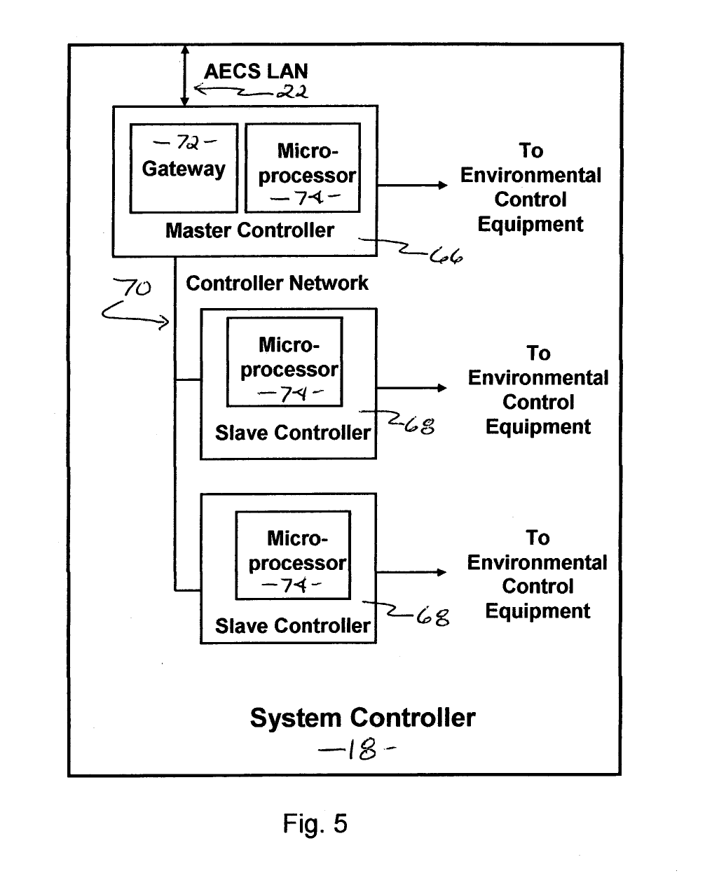

A System Controller 18 and its associated environmental control equipment are illustrated in FIG. 5. In the preferred embodiment of the invention, parametric information, set-point requests, weather forecasts, and current utility rate information arrives over the AECS LAN 22. A Master Controller 66 receives the information and directs the activity of Slave Controllers 68 over a controller network 70. In the preferred embodiment of the invention, the controller network 70 is an RS485 local area network. The Master Controller 66 possesses an Ethernet Gateway 72 for communicating with the AECS LAN 22 and a micro-processor 74 for processing the arriving information.

The Slave Controllers 68 possess micro-processors 74 but do not possess Ethernet Gateways 72 as they are not directly connected to the AECS LAN 22. Both Master Controllers 66 and Slave Controllers 68 direct the activity of attached environmental control equipment such as air conditioners 12, VAV boxes 14, and lighting systems 16.

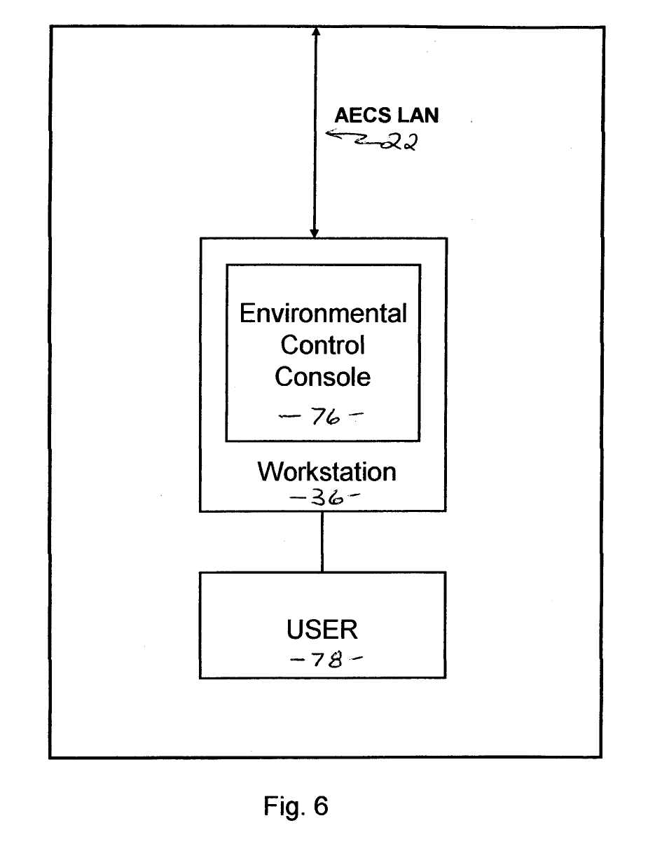

As illustrated by the block diagram of FIG. 6, a key feature of the preferred embodiment of the invention is a software application called Environment Control Console 76 which resides on individual users' workstations 36, allowing users 78 to request changes to the environmental set-points such as temperature, air-flow, and lighting. Even if a user does not have an AECS sensor 32 attached to his workstation, the software application may be utilized to generate set-point requests. Requests generated by the software application are transmitted along the same AECS LAN 22 used for the transmission of parametric information to the system controllers 18. Multiple set-point requests originating from the same Zone 20 averaged together by the system controllers 18 to generate a composite set-point. This composite set-point is the target value utilized to manage the activity of the environmental control equipment.

However, not all users may be given the same deference to their set-point requests. Set-point requests from some users may be given more weight than others. In this manner, a weighted average composite set-point is utilized.

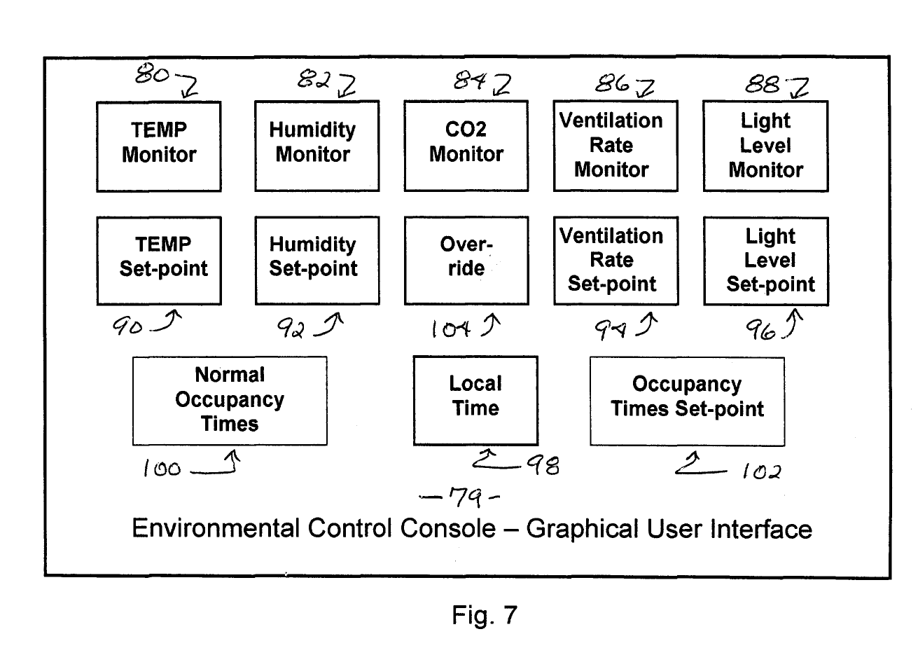

Turning to FIG. 7, a graphical user interface (“GUI”) exemplary of the display of the Environmental Control Console 76 is shown. Users 78 can monitor the environmental parameters of their respective Zone 20 by observing the temperature display 80, the humidity display 82, the CO2 level display 84, the ventilation rate display 86, and the light level display 88. Additional displays for current local time 98 and normal occupancy times 100 may be provided. If an AECS sensor 32 is not attached to the workstation 36 containing the ECC, these displays may be blank or may contain information which is provided by the EMS 30.

User selectable graphical display buttons may be selected by the user 78 to request changes to the respective set-points, i.e., temperature request 90, humidity request 92, ventilation request 94, and light level request 96. In most embodiments of the invention, a graphical display button allowing users 78 to request changes to the CO2 level will probably not be available. Additional user selectable graphical display buttons may be provided, allowing the user 78 to adjust the occupancy times 102 and over-ride the current set-point criteria 104. In the preferred embodiment of the invention, these user selectable graphical display buttons will be made available to all users 78, whether or not they have AECS sensors 32 attached to their respective workstations 36. When the ECC GUI 79 is not prominently displayed in the computer monitor 34 of the workstation 36, an icon displaying the current temperature may be placed in the program tray of the workstation's operating system display.

The EMS server 30 (FIG. 1) is used to gather and record weather and utility information from Web Services 28, parametric information from AECS sensors 32, and equipment operating parameters from the System Controllers 18. Parametric information is forwarded to the system controllers 18. Records of all set-point requests may be kept to correlate the relationship between users 78 and the amount of energy required to manage the environment. In commercial settings where more than one company may be in a single Zone 20, these records can assist in distributing utility bills pro-rata.

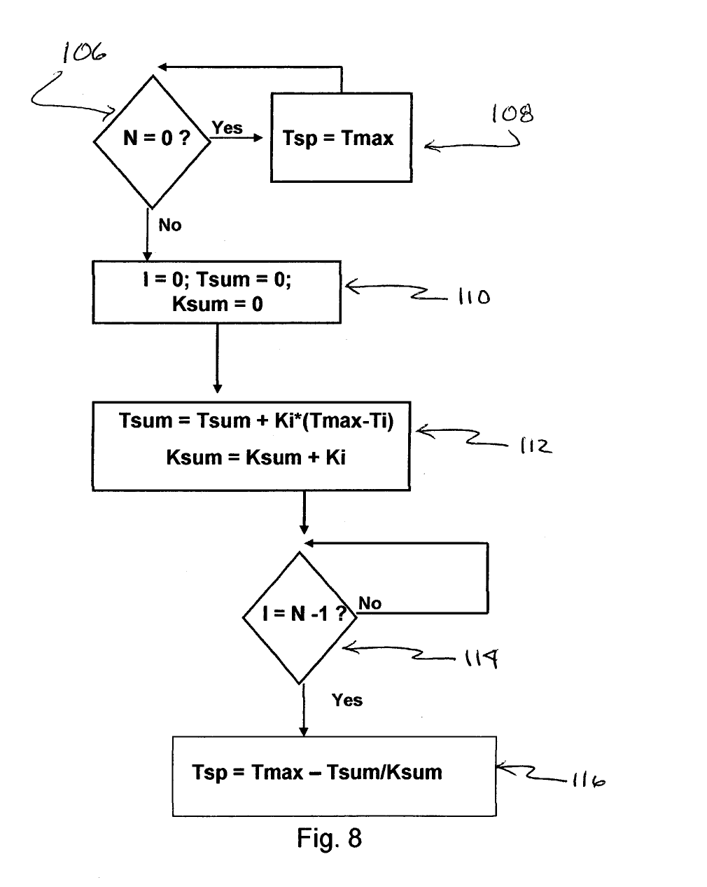

If multiple users request changes to environmental set-points within the same Zone 20, an algorithm is used to generate a composite set-point, as illustrated in FIG. 8. In this example, HVAC equipment is being used to cool the work environment occupied by multiple users 78.

A maximum acceptable temperature (“Tmax”) is used as the default set-point. Should the temperature in the Zone 20 exceed Tmax, a System Controller 18 will direct an air conditioning unit 12 to operate until the ambient Zone temperature reaches some pre-determined point below Tmax. Those skilled in the art will recognize that few environmental control systems will be configured to turn off as soon as the temperature is less than or equal to Tmax, as this would result in the air conditioner 12 being excessively cycled on and off, reducing energy efficiency and increasing wear on the equipment.

Tsp is the variable utilized to hold the current temperature set-point, i.e., the composite temperature set-point which replaces Tmax in controlling the operation of the air conditioner 12. A variable “N” is used to track how many users 78 are requesting changes to the temperature set-point and Ti is used to store the temperature requested by each user 78. Ki is the variable used to store the weight given to a particular user. In the preferred embodiment of the invention, the weight is a decimal value ranging from 0.1 to 1.0.

Ksum is a variable used to store the summation of all Ki and Tsum is a variable used to store the summation of weighted set-point requests. A counting variable “I” is also utilized for algorithmic loop control.

In step 106 if no users 78 are requesting changes to the current temperature set-point, then N=0 and Tsp equals Tmax 108. However, if N is greater than zero, then variables Tsum, Ksum, and I are initialized to zero in step 110. In step 112, Tsum is incremented by the user weight Ki multiplied by the difference between Tmax and the user's set-point request Ti, according to the following equation:

Tsum=Tsum+Ki*(Tmax−Ti).

Likewise, Ksum is incremented by the user weight Ki, according to the following:

Ksum=Ksum+Ki

and the counting variable I is incremented.

In step 114, the counting variable is evaluated against the number of requesters N. If I is less than N−1, then the algorithm returns to step 112. Else, the algorithm moves to step 116 where Tsp is calculated according to the equation:

Tsp=Tmax−Tsum/Ksum

The new temperature set-point, Tsp, is then used by the System Controllers 18 to direct the behavior of the air conditioners 12. Similar algorithms are utilized to generate composite set-points for heaters, fans, VAV boxes, and lighting systems.

Others skilled in the art of artificial environment control systems may develop other embodiments of the present invention. The embodiments described herein are but a few of the modes of the invention. Therefore, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. An artificial environment control system, comprising:
at least one artificial environment control system (“AECS”) sensor for obtaining parametric environmental information;
at least one workstation including a computer monitor;
at least one System Controller;
at least one environmental control device;
a means for connecting said at least one AECS sensor to said at least one workstation;
a means for connecting said at least one workstation to said at least one System Controller; and
a means for connecting said at least one System Controller to said at least one environmental control device, wherein said parametric environmental information is transmitted from said at least one AECS sensor to said at least one workstation, and from said at least one workstation to said at least one System Controller.

2. The artificial environment control system of claim 1, further comprising:
an Environmental Management Server (“EMS server”) connected to said means for connecting said at least one workstation to said at least one System Controller.

3. The artificial environment control system of claim 2, further comprising:
a router for connecting said means for connecting said at least one workstation to said at least one System Controller to the Internet.

4. The artificial environment control system of claim 3, further comprising Web Services, wherein said Web Services are accessible through the Internet.

5. The artificial environment control system of claim 4, wherein said Web Services provide current local weather information.

6. The artificial environment control system of claim 5, wherein said Web Services provide current utility rate information.

7. The artificial environment control system of claim 6, wherein said EMS server obtains said current local weather information and said current utility rate information from said Web Services.

8. The artificial environment control system of claim 7, wherein said at least one AECS sensor comprises:
a plurality of environmental sensors for providing environmental information;
a power source; and
a sensor processing device for accepting said environmental information, producing parametric environmental information representative of said environmental information, and transmitting said parametric environmental information to said at least one workstation.

9. The artificial environment control system of claim 8, wherein said plurality of environmental sensors comprises a temperature sensor.

10. The artificial environment control system of claim 8, wherein said plurality of environmental sensors comprises a light sensor.

11. The artificial environment control system of claim 8, wherein said plurality of environmental sensors comprises a humidity sensor.

12. The artificial environment control system of claim 8, wherein said plurality of environmental sensors comprises a carbon dioxide sensor.

13. The artificial environment control system of claim 8, wherein said plurality of environmental sensors comprises a infra-red light sensor.

14. The artificial environment control system of claim 8, wherein said AECS sensor further comprises:
a first Universal Serial Bus (“USB”) connector; and
a data bus for connecting said USB connector to said sensor processing device.

15. The artificial environment control system of claim 14, wherein said workstation comprises:
a power supply; and
a second USB connector.

16. The artificial environment control system of claim 15, wherein said means for connecting said at least one AECS sensor to said at least one workstation is a USB cable attached to said first USB connector on one end and attached to said second USB connector on the other end.

17. The artificial environment control system of claim 16, wherein said AECS sensor power source is a workstation power supply, said power supply transmitting electrical power over said USB cable to said AECS sensor.

18. The artificial environment control system of claim 8, wherein said means for connecting said at least one AECS sensor to said at least one workstation is a set of radio transceivers for sending and receiving data.

19. The artificial environment control system of claim 8, wherein said at least one System Controller comprises:
a Master Controller including a controller processing device and a Gateway for connecting said Master Controller to said AECS LAN;
at least one Slave Controller including a controller processing device; and
a controller network for connecting said Master Controller to said at least one Slave Controller.

20. The artificial environment control system of claim 8, wherein said workstation further comprises an Environmental Control Console (“ECC”) software application.

21. The artificial environmental control system of claim 20, wherein said ECC software application is utilized by users to monitor parametric environmental information.

22. The artificial environmental control system of claim 21, wherein said EMS server maintains a plurality of environmental set-points, said plurality of environmental set-points corresponding to said parametric environmental information.

23. The artificial environmental control system of claim 22, wherein said at least one System Controller utilizes said local weather forecast information, said current utility rate information, and said environmental set-points to direct the behavior of said at least one environmental control device.

24. The artificial environmental control system of claim 22, wherein said ECC software application is utilized by a user to request changes to said environmental set-points.

25. The artificial environmental control system of claim 24, wherein said artificial environmental control system controls the environment of a large area, said large area being divided into a plurality of Zones.

26. The artificial environmental control system of claim 25, wherein at least one Zone of said plurality of zones contain a plurality of said at least one workstations.

27. The artificial environment control system of claim 26, wherein a plurality of users utilizes said plurality of said at least one workstations to generate a plurality of requests of said changes to said environmental set-points.

28. The artificial environment control system of claim 27, wherein said EMS server receives said plurality of requests of said changes to said environmental set-points and generates a composite set-point.

29. The artificial environment control system of claim 28, wherein said composite set-point is an average of the plurality of requests of said changes to said environmental set-points.

30. The artificial environment control system of claim 28, wherein each request of said plurality of requests of said changes to said environment set-points is given a weighted value, said weighted value being one of a plurality of discrete values within a range of values, and further wherein said composite set-point is an weighted average of the plurality of requests of said changes to said environmental set-points.

31. The artificial environment control system of claim 8, wherein said means for connecting said at least one workstation to said at least one System Controller is a local area network (“AECS LAN”).

32. The artificial environment control system of claim 31, wherein said AECS LAN is an Ethernet Network.

33. The artificial environment control system of claim 31, wherein said AECS LAN is a wireless network.

34. The artificial environment control system of claim 8, wherein said means for connecting said at least one System Controller to said at least one environmental control device is a set of wires.

35. The artificial environmental control system of claim 8, wherein said means for connecting said at least one System Controller to said at least one environmental control device is a set of transceivers for sending and receiving data.
